(19) United States
(12) Patent Application Publication
(10) Pub. No.: US 2007/0037043 A1
(43) Pub. Date: Feb. 15, 2007

(54) Pretreatment method of electrode active material

(76) Inventors: Sung Kyun Chang, Yuseong-gu (KR); Eui Yong Bang, Seo-gu (KR); Min Chul Jang, Yuseong-gu (KR); Sang Hoon Choy, Yuseong-gu (KR); Ki Young Lee, Yuseong-gu (KR)

Correspondence Address: CANTOR COLBURN, LLP, 55 GRIFFIN ROAD SOUTH, BLOOMFIELD, CT, 06002, US

(21) Appl. No.: 11/491,215

(22) Filed: Jul. 21, 2006

(30) Foreign Application Priority Data
Jul. 22, 2005 (KR) 10-2005-0066814

(51) Int. Cl. H01M 10/44; H01M 4/48

(52) U.S. Cl. 429/50; 429/231.1

(57) ABSTRACT

Disclosed is a pretreatment method for activating an electrode active material having a certain range of potential plateau beyond a redox potential range of a transition metal forming the electrode active material, which comprises charging the electrode active material to an extent exceeding the potential plateau at least once, so as to increase capacity of the electrode active material. Also, disclosed is an electrochemical device comprising the electrode active material activated by the pretreatment method and designed to be subjected to charge/discharge cycles at a voltage lower than the potential plateau. When the electrode active material pretreated by charging it to an extent exceeding the potential plateau is subjected to charge/discharge cycles at a lower voltage, it is possible to significantly increase the capacity of the electrode active material as compared to the capacity of the non-pretreated electrode active material charged/discharged at the same voltage. It is also possible to inhibit reactivity of an electrolyte by performing charging/discharging at a lower voltage from the charge cycle subsequent to the pretreatment.

This application claims the benefit of the filing date of Korean Patent Application No. 2005-66814, filed on Jul. 22, 2005, respectively in the Korean Intellectual Property Office, the disclosure of which is incorporated herein in its entirety by reference.

### TECHNICAL FIELD

The present invention relates to a pretreatment method of an electrode active material.

### BACKGROUND ART

As the mobile communication industry and the information electronics industry have advanced markedly in recent years, lithium secondary batteries with high capacity and low weight have been increasingly in demand. However, since mobile instruments have been multi-functionalized, energy consumption thereof has increased. Thus, batteries used in such instruments as drive sources have been required to be provided with higher power and capacity. Additionally, active and intensive research and development have been conducted to substitute cobalt (Co) that is expensive and limited in supply with inexpensive nickel (Ni), manganese (Mn), iron (Fe) or the like.

However, LiMn₂Co₄ provides lower battery capacity when compared to LiCoO₂ by about 20% and shows a problem of Mn dissolution at higher temperature. Additionally, LiNiO₂ provides an improved energy density when compared with LiCoO₂, but shows a safety-related problem. Further, LiFePO₄ provides about lower capacity when compared with LiCoO₂ by about 20% and shows a problem related to C-rate characteristics.

### DISCLOSURE OF THE INVENTION

Techniaca Data

Therefore, the present invention has been made in view of the above-mentioned problems. The inventors of the present invention have found that when an electrode active material having a certain range of potential plateau beyond the redox potential range of a transition metal forming the electrode active material is pretreated by charging it to an extent exceeding the potential plateau, and then by being subjected to charge/discharge cycles under a charging voltage lower than the potential plateau, the electrode active material provides an increased capacity as compared with the non-pretreated electrode active material subjected to charge/discharge cycles under the same charging voltage. The present invention is based on this finding.

Technical Solution

According to an aspect of the present invention, there is provided a treatment method for activating an electrode active material having a certain range of potential plateau beyond the redox potential range of a transition metal forming the electrode active material, which comprises charging the electrode active material to an extent exceeding the potential plateau at least once, so as to increase capacity of the electrode active material.

According to another aspect of the present invention, there is provided an electrochemical device comprising an electrode active material that has a certain range of potential plateau beyond the redox potential range of a transition metal forming the electrode active material, and is charged to an extent exceeding the potential plateau at least once, the electrochemical device being designed to be subjected to charge/discharge cycles at a level lower than the potential plateau.

According to still another aspect of the present invention, there is provided an electrochemical device comprising an electrode active material having a certain range of potential plateau beyond the redox potential range of a transition metal forming the electrode active material, the electrochemical device including a means that allows the electrochemical device to be charged to an extent exceeding the potential plateau at least once, and then to be subjected to charge/discharge cycles at a voltage lower than the potential plateau.

According to yet another aspect of the present invention, there is provided an electrode active material, which has a certain range of potential plateau beyond the redox potential range of a transition metal forming the electrode active material, and is charged to an extent exceeding the potential plateau at least once.

According to yet another aspect of the present invention, there is provided a compound represented by the following Formula 1 or a derivative thereof which has a discharge capacity ranging from 100 mAh/g to 280 mAh/g in a voltage range of 3.0V˜4.4V:
XLi(Li_{1/3}M_{2/3})O₂+YLiM′O₂ (solid solution) [Formula 1]

Wherein M is at least one element selected from the group consisting of metals having an oxidation number of 4+;

M′ is at least one element selected from transition metals; and

0<X<1 and 0<Y<1, with the proviso that X+Y=1.

Hereinafter, the present invention will be explained in more detail.

All materials involved in chemical reactions cause an electron transfer phenomenon upon the chemical reactions, and each material causes a reaction at its unique electrochemical potential (−ΔG/nF). Different materials have different potentials and induce a potential difference. The basic principle of a battery is in the use of a potential difference between different materials. Although any materials may form batteries, practically applicable batteries should have high capacity. This means that materials that can be used to form batteries must provide a high quantity of electricity when being charged/discharged in an applicable potential range.

A lithium ion battery is one based on intercalation chemistry, and utilizes a cathode active material and an anode active material capable of electrochemical lithium intercalation/deintercalation, and an aprotic polar organic solvent as a medium capable of transporting lithium ions. Meanwhile, most electrode active materials include layered compounds having such a structure that allows ion transfer between Van der Waals layers, or materials having a three-dimensional ion transfer path.

Some electrode active materials, i.e. compounds represented by the above Formula 1, have a certain range of potential plateau beyond the oxidation/reduction potentials defined by variations in oxidation numbers of the constitutional elements of the electrode active materials during charge/discharge cycles.

Such electrode active materials generally generate oxygen in the range of potential plateau. This serves to stabilize materials showing instability caused by an increase in voltage. In other words, upon the first charge cycle, Li is deintercalated not by oxidation/reduction of a transition metal forming the electrode active material but by the liberation of oxygen. When oxygen is liberated, charge valance is not made between oxygen and metals in the structure of the material, and thus Li deintercalation occurs to solve this problem. Such deintercalated Li may be intercalated back into a cathode while the transition metal (e.g. Mn) forming the electrode active material experiences a change in its oxidation number from 4+ to 3+ upon discharge. In other words, after the aforementioned O₂ defect is generated (i.e. the electrode active material is activated), the charge/discharge cycles can be accomplished via oxidation/reduction of the transition metal forming the electrode active material. Herein, although the transition metal (e.g. Mn) reduced from an oxidation number of 4+ to an oxidation number of 3+ does not participate in lithium (Li) intercalation/deintercalation upon the first charge cycle, it may participate in charge/discharge after the first charge cycle, thereby increasing reversible capacity.

In general, the compound represented by the following Formula 1 has a certain range of potential plateau in a voltage range higher than the redox potential range of a transition metal contained in the compound, for example, in a range of 4.4V˜4.6V, in addition to the redox potential range:
XLi(Li_{1/3}M_{2/3})O₂+YLiM′O₂ (solid solution) [Formula 1]

Wherein M is at least one element selected from the group consisting of metals having an oxidation number of 4+;

M′ is at least one element selected from transition metals; and

0<X<1 and 0<Y<1, with the proviso that X+Y=1.

When the electrode active material is subjected to a charge cycle at a potential level higher than the redox potential of M′, Li is deintercalated from the electrode active material while oxygen is also deintercalated to correct the redox valence. In this manner, the electrode active material shows a potential plateau.

Preferably, M is at least one element selected from the group consisting of Mn, Sn and Ti metals, and M′ is at least one element selected from the group consisting of Ni, Mn, Co and Cr metals.

Meanwhile, the lithium ion secondary battery systems that are currently used are problematic in that side reactions may occur between an electrode active material and an electrolyte under an increased voltage exceeding a certain voltage limit.

Most conventional electrolyte systems that are currently used have a voltage limit of 4.4V on the basis of cathode potential.

For example, when a battery using a conventional electrolyte system stable at 4.2V, is subjected continuously to charge/discharge cycles at a charging voltage (4.4˜4.8V) higher than the potential plateau of the compound represented by Formula 1, the quality of the battery is adversely affected by the reaction between the electrode active material and the electrolyte. Meanwhile, when the battery is subjected to charge/discharge cycles at a voltage lower than the potential plateau, the battery shows a very low capacity.

In other words, the electrode active material represented by Formula 1 should be subjected to charge/discharge cycles at a voltage higher than the potential plateau in order to provide a battery with high capacity. However, in this case, side reactions may occur between the electrode active material and a currently used electrolyte system, resulting in degradation of the quality of the battery. Particularly, such side reactions become severe at a high temperature.

Under these circumstances, the inventors of the present invention have conducted intensive studies and have found that when a battery is charged to an extent exceeding a certain range of potential plateau present beyond the redox potential of a transition metal forming an electrode active material upon the first charge cycle, and then is subjected to charge/discharge cycles at lower voltage, at which the electrolyte is stable and no side reactions adversely affecting the quality of the battery occur, from the second charge cycle, the battery can provide higher capacity as compared to the same battery subjected to charge/discharge cycles at lower voltage from the first charge cycle. Therefore, when a battery is charged to an extent exceeding the potential plateau and then is subjected to charge/discharge cycles at a lower voltage, the battery can, without any problem, provide high capacity even at such a low voltage that side reactions of an electrolyte cannot occur.

Particularly, the compound represented by Formula 1 is preferred because it provides high capacity and still serves as a stable electrode active material during the subsequent charge/discharge cycles conducted at a lower charging voltage after carrying out the pretreatment method that comprises charging the electrode active material to a voltage (4.4˜4.8V) higher than the potential plateau. On the contrary LiCoO₂ is problematic in that lithium transfer paths are blocked due to the breakage of the layered structure to increase the irreversible capacity, resulting in degradation of the quality of the battery.

When an electrode active material comprising the compound represented by Formula 1 is activated by the pretreatment method according to the present invention, the electrode active material can have a discharge capacity of 100˜280 mAh/g, preferably 170˜220mAh/g in a voltage range of 3.0˜4.4V. When the electrode active material is not pretreated as described above, it shows a discharge capacity of approximately 90mAh/g in the same voltage range. Therefore, the pretreatment method according to the present invention can provide a significantly increased capacity (see FIGS. 1˜3).

In brief, the present invention is characterized by preparing a battery using a cathode formed of a cathode active material such as a compound represented by Formula 1, by charging the battery to an extent exceeding a potential plateau (e.g. 4.4˜4.6V) present beyond the redox potential range of the transition metal in the cathode active material upon the first charge cycle, and by subjecting the battery to charge/discharge cycles at a lower voltage from the second charge/discharge cycle in order to inhibit the reactivity of the cathode active material with an electrolyte.

According to an embodiment of the present invention, an electrode is provided by using the electrode active material, a battery is manufactured by introducing a separator and an electrolyte thereto, and then the electrode active material is pretreated by charging the battery to an extent exceeding the potential plateau beyond the redox potential of the transition metal before it is charged for forwarding.

Particularly, such pretreatment of the electrode active material is performed preferably upon the first charge cycle.

The batteries pretreated before being charged for forwarding as described above may be designed and forwarded in such a manner that they are used at a voltage lower than the potential plateau by users.

Additionally, if a battery is not pretreated before forwarding, the battery may further comprise a means that allows the battery to be pretreated in the aforementioned manner after forwarding, i.e. a means that allows the battery to be charged to an extent exceeding the potential plateau at least once, and then subjected to charge/discharge cycles at a voltage lower than the potential plateau. For example, the battery may further comprise a switching circuit that allows the battery to be charged to an extent (e.g. 4.4˜4.6V) exceeding the potential plateau for a predetermined number of cycles after the first cycle(at least once), and then subjected to charge/discharge cycles at a voltage lower than the potential plateau upon the subsequent charge/discharge cycle.

Additionally, the means includes description of the above technical content in the manual of a battery, or a sticker including the above description and attached to a battery.

Hereinafter, the electrochemical device comprising the electrode active material obtained by the pretreatment according to the present invention, or subsequently subjected to the pretreatment method according to the present invention will be explained in more detail.

Preferably, the electrochemical device according to the present invention is a lithium ion battery.

In general, a lithium ion battery comprises a cathode having cathode active material slurry and a cathode collector, an anode having anode active material slurry and an anode collector, and a separator interposed between both electrodes in order to interrupt electron conduction and to perform lithium ion conduction between both electrodes. Also, a lithium salt-containing organic electrolyte is injected into the void of the electrodes and the separator.

In one embodiment of the present invention, the electrode active material pretreated according to the present invention, for example, a cathode active material represented by Formula 1 may be used alone or in combination with at least one cathode active material selected from the following group of cathode active materials to provide a cathode: LiCoO₂, LiNiO₂, LiMnO₂, LiMn₂O4, Li(NiₐCo_{b}Mn_{c})O₂ (wherein 0<a<1, 0<b<1, 0<c<1, and a+b+c=1), LiNi_{1-Y}Co_{Y}O₂, LiCo_{1-Y}Mn_{Y}O₂, LiNi_{1-Y}Mn_{Y}O₂ (wherein 0≦Y<1), Li(NiₐCo_{b}Mn_{c})O₄(0<a<2, 0<b<2, 0<c<2, a+b+c=2), LiMn_{2-z}Ni_{z}O₄, LiMn_{2-z}Co_{z}O₄ (wherein 0<Z<2), LiCoPO₄, and LiFePO₄.

For example, the cathode can be obtained by applying a mixture containing the above-described cathode active material, a conductive agent and a binder onto a cathode collector, followed by drying. If desired, the mixture may further comprise fillers.

The cathode collector generally has a thickness of 3˜500 μm. There is no particular limitation in the cathode collector, as long as it has high electrical conductivity while not causing any chemical change in the battery using it. Particular examples of the cathode collector that may be used in the present invention include stainless steel, aluminum, nickel, titanium, sintered carbon, or aluminum or stainless steel surface-treated with carbon, nickel, titanium, silver or the like. The collector may have fine surface roughness to increase the adhesion of the cathode active material thereto, and may be formed into various shapes, including a film, sheet, foil, net, porous body, foamed body, non-woven body, or the like.

Generally, the conductive agent is added to the mixture containing the cathode active material in an amount of 1˜50 wt % based on the total weight of the mixture. There is no particular limitation in the conductive agent, as long as it has electrical conductivity while not causing any chemical change in the battery using it. Particular examples of the conductive agent that may be used in the present invention include: graphite such as natural graphite or artificial graphite; carbon black such as carbon black, acetylene black, ketjen black, channel black, furnace black, lamp black, thermal black, etc.; conductive fiber such as carbon fiber or metal fiber; metal powder such as fluorocarbon, aluminum, nickel powder, etc.; conductive whisker such as zinc oxide, potassium titanate, etc.; conductive metal oxides such as titanium oxide; and other conductive materials such as polyphenylene derivatives.

The binder facilitates binding between the active material and the conductive agent or the like and binding of the active material to the collector. Generally, the binder is added to the mixture containing the cathode active material in an amount of 1˜50 wt % based on the total weight of the mixture. Particular examples of the binder that may be used in the present invention include polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, styrene butylene rubber, fluororubber, various copolymers, or the like.

The fillers are used optionally in order to prevent the cathode from swelling. There is no particular limitation on the fillers, as long as they are fibrous material while not causing any chemical change in the battery using them. Particular examples of the fillers that may be used in the present invention include olefin polymers such as polyethylene, polypropylene, etc.; and fibrous materials such as glass fiber, carbon fiber, etc.

The anode can be obtained by applying a mixture containing an anode active material onto an anode collector, followed by drying. If desired, the mixture may further comprise the additives as described above.

The anode collector generally has a thickness of 3˜500 μm. There is no particular limitation in the anode collector, as long as it has electrical conductivity while not causing any chemical change in the battery using it. Particular examples of the anode collector that may be used in the present invention include copper, stainless steel, aluminum, nickel, titanium, sintered carbon, copper or stainless steel surface-treated with carbon, nickel, titanium, silver, etc., aluminum-cadmium alloy, or the like. Additionally, like the cathode collector, the anode collector may have fine surface roughness to increase the adhesion of the anode active material thereto, and may be formed into various shapes, including a film, sheet, foil, net, porous body, foamed body, non-woven body, or the like.

Particular examples of the anode active material that may be used in the present invention include: carbon such as hard carbon or graphitized carbon; metal composite oxides such as LiₓFe₂O₃(0≦x≦1), LiₓWO₂(0≦x≦1), SnₓMe₁₋ₓMe′_{y}O_{z} (wherein Me represents Mn, Fe, Pb or Ge; Me′ represents Al, B, P, Si, a Group I, II or III element in the Periodic Table or a halogen atom; 0<x<1; 1<y<3 ; and 1<z<8); lithium metal; lithium alloy; silicon alloy; tin alloy; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni-based materials.

The separator is interposed between the cathode and the anode, and includes a thin film having insulation property and showing high ion permeability and mechanical strength. The separator generally has a pore diameter of 0.01˜10 μm and a thickness of 5˜300 μm. Particular examples of the separator that may be used in the present invention include: olefin polymers such as polypropylene with chemical resistance and hydrophobicity; and sheets or non-woven webs formed of glass fiber or polyethylene. When a solid electrolyte such as a polymer electrolyte is used, the solid electrolyte may serve also as a separator.

The non-aqueous electrolyte includes a cyclic carbonate and/or linear carbonate as an electrolyte compound. Particular examples of the cyclic carbonate include ethylene carbonate (EC), propylene carbonate (PC), gamma-butyrolactone (GBL), or the like. Preferably, the linear carbonate is selected from the group consisting of diethyl carbonate (DEC), dimethyl carbonate (DMC), ethyl methyl carbonate (EMC) and methyl propyl carbonate (MPC), but is not limited thereto. Additionally, the non-aqueous electrolyte further comprises a lithium salt in addition to the carbonate compound. Preferably, the lithium salt is selected from the group consisting of LiClO₄, LiCF₃SO₃, LiPF₆, LiBF₄, LiAsF₆ and LiN(CF₃SO₂)₂, but is not limited thereto.

The lithium ion battery according to the present invention is manufactured by introducing a porous separator between a cathode and an anode and injecting a non-aqueous electrolyte thereto in a conventional manner.

The lithium ion battery according to the present invention may have any outer shape, such as a cylindrical shape, a prismatic shape, a pouch-like shape, or the like.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a graph illustrating charge/discharge characteristics of the battery charged to a voltage of 4.8V upon the first cycle, and to a voltage of 4.4V from the second cycle according to Example 1;

FIG. 2 is a graph illustrating charge/discharge characteristics of the battery charged to 4.25V according to Comparative Example 1;

FIG. 3 is a graph illustrating charge/discharge characteristics of the battery charged to 4.4V according to Comparative Example 2;

FIG. 4 is a graph illustrating charge/discharge characteristics of the battery charged to a voltage of 4.6V upon the first cycle, and to a voltage of 4.4V from the second cycle according to Comparative Example 7 ; and

FIG. 5 is a graph illustrating charge/discharge characteristics of the battery charged to 4.4V according to Comparative Example 8.

### MODE FOR CARRYING OUT THE INVENTION

Reference will now be made in detail to the preferred embodiments of the present invention. It is to be understood that the following examples are illustrative only, and the scope of the present invention is not limited thereto.

### EXAMPLE 1

Cathode active material slurry was formed by using Li(Li_{0.2}N_{i0.2}Mn_{0.6})O₂ (⅗[Li(Li_{1/3}Mn_{2/3})O₂]+⅖[LiNi_{1/2}Mn_{1/2}]O₂) as a cathode active material and mixing the cathode active material with carbon as a conductive agent and PVDF as a binder in a weight ratio of 88:6:6. The cathode active material slurry was coated on Al foil having a thickness of 151 μm to provide a cathode. Artificial graphite was used as an anode active material and 1M LiPF₆ solution in EC:EMC (weight ratio 1:2) was used as an electrolyte to provide a coin type battery.

The battery was charged/discharged in a voltage range of 3˜4.8V upon the first cycle. Then, the battery was charged/discharged in a voltage range of 3˜4.4V from the 2^{nd} cycle to the 50^{th} cycle. The charge/discharge cycles were performed at 23° C.

### COMPARATIVE EXAMPLE 1

The battery obtained in the same manner as described in Example 1 was subjected to charge/discharge cycles in a voltage range of 3˜4.25V from the first cycle to the 50^{th} cycle.

### COMPARATIVE EXAMPLE 2

The battery obtained in the same manner as described in Example 1 was subjected to charge/discharge cycles in a voltage range of 3˜4.4V from the first cycle to the 50^{th} cycle.

### COMPARATIVE EXAMPLE 3

The battery obtained in the same manner as described in Example 1 was subjected to charge/discharge cycles in a voltage range of 3˜4.8V from the first cycle to the 50th cycle.

### EXAMPLE 2

The battery obtained in the same manner as described in Example 1 was subjected to charge/discharge cycles in the same manner as described in Example 1, except that the charge/discharge cycles were performed at 50° C.

### COMPARATIVE EXAMPLE 4

The battery obtained in the same manner as described in Comparative Example 1 was subjected to charge/discharge cycles in the same manner as described in Comparative Example 1, except that the charge/discharge cycles were performed at 50° C.

### COMPARATIVE EXAMPLE 5

The battery obtained in the same manner as described in Comparative Example 2 was subjected to charge/discharge cycles in the same manner as described in Comparative Example 2, except that the charge/discharge cycles were performed at 50° C.

### COMPARATIVE EXAMPLE 6

The battery obtained in the same manner as described in Comparative Example 3 was subjected to charge/discharge cycles in the same manner as described in Comparative Example 3, except that the charge/discharge cycles were performed at 50 ° C.

### COMPARATIVE EXAMPLE 7

The battery obtained in the same manner as described in Example 1, except that LiCoO₂ was used as a cathode active material, was charged/discharged in a voltage range of 3˜4.6V upon the first cycle. Then, the battery was charged/discharged in a voltage range of 3˜4.4V from the 2^{nd} cycle to the 50^{th} cycle. The charge/discharge cycles were performed at 23° C.

### COMPARATIVE EXAMPLE 8

The battery obtained in the same manner as described in Comparative Example 7 was subjected to charge/discharge cycles in a voltage range of 3˜4.4V from the first cycle to the 50^{th} cycle.

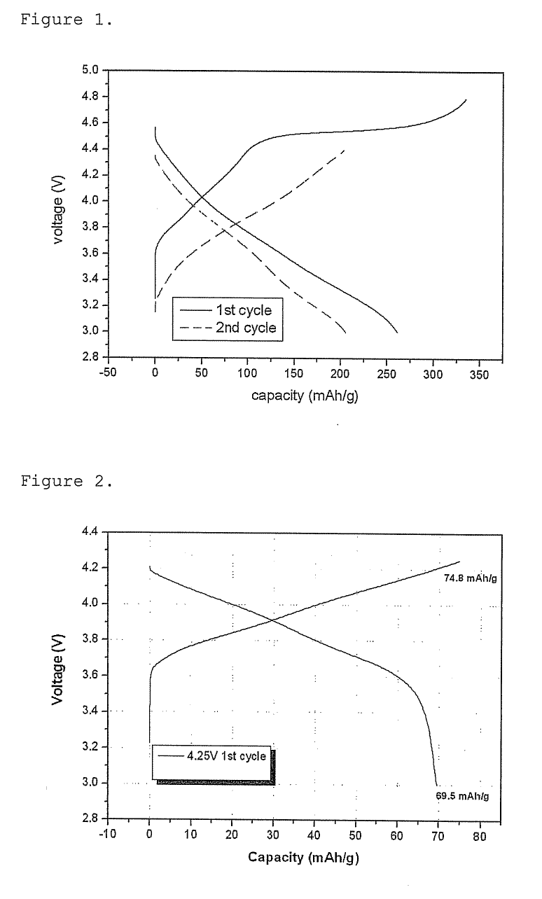

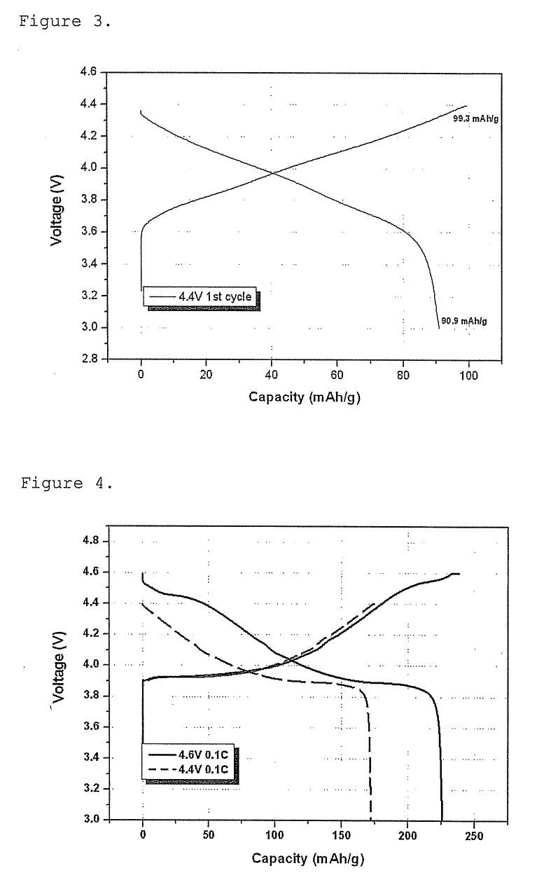

FIGS. 1˜3 are graphs each illustrating charge/discharge characteristics of the battery charged to the same voltage as described in Example 1 and Comparative Examples 1 and 2.

As shown in FIGS. 1˜3, the cathode active material represented by the above Formula 1 has a potential plateau in a voltage range of 4.4˜4.6V in the first charge period. When the battery comprising the cathode active material is charged to a voltage exceeding the potential plateau upon the first charge cycle and then the voltage is decreased to a level lower than the potential plateau according to example 1, the battery shows a significantly increased capacity as compared to the same battery charged continuously to a voltage lower than the potential plateau according to Comparative Example 2 or 3.

The following Table 1 shows the charge/discharge characteristics of the batteries charged to the same voltage under the same temperature as described in Examples 1 and 2 and Comparative Examples 1˜6.

TABLE 1

| | Discharge capacity at the 50^{th} cycle/ |
|---|---|
| | Discharge capacity at the 2^{nd} cycle (%) |
| Ex. 1 | 97.8 |
| Comp. Ex. 1 | 98.2 |
| Comp. Ex. 2 | 97.2 |
| Comp. Ex. 3 | 75.6 |
| Ex. 2 | 92.7 |
| Comp. Ex. 4 | 93.6 |
| Comp. Ex. 5 | 92.2 |
| Comp. Ex. 6 | 52.8 |

As mentioned above, in a currently used electrolyte system, side reactions occur between an electrode active material and the electrolyte as the voltage increases, such side reactions affecting the quality of a battery. When comparing Example 1 with Comparative Example 2 and Example 2 with Comparative Example 5, it can be seen that the batteries (Examples 1 and 2) charged to an extent exceeding the potential plateau and then subjected to a lower voltage, provide a significantly increased capacity as compared with the capacity of the batteries subjected to charge/discharge cycles at a voltage lower than the potential plateau (see FIGS. 1˜3). Also, in the batteries according to Examples 1 and 2, it is possible to prevent side reactions occurring between the electrode active material and the electrolyte at a high voltage (see Table 1).

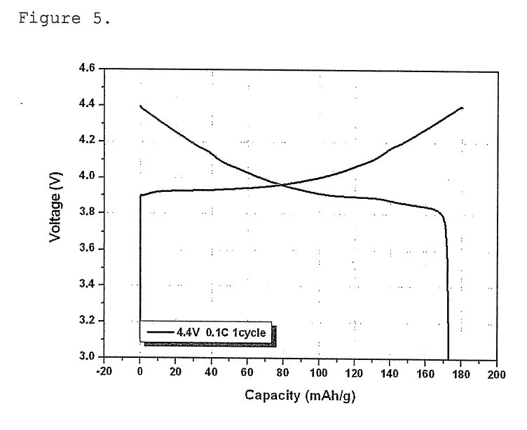

Meanwhile, FIGS. 4 and 5 show the test results of Comparative Examples 7 and 8. It can be seen from the results that LiCoO₂ having no potential plateau cannot provide any increase in capacity even if the battery using LiCoO₂ is charged at 4.6V upon the first charge cycle and then charged/discharged at 4.4V from the second cycle.

### INDUSTRIAL APPLICABILITY

As can be seen from the foregoing, an electrode active material having a certain range of potential plateau beyond the redox potential range of a transition metal forming the electrode active material is pretreated by charging it to an extent exceeding the potential plateau according to the present invention. When such pretreated electrode active material is subjected to charge/discharge cycles at a lower voltage, it is possible to significantly increase the capacity of the electrode active material as compared to the capacity of the non-pretreated electrode active material charged/discharged at the same voltage. It is also possible to inhibit reactivity of an electrolyte by performing charge/discharge cycles at a lower voltage from the charge cycle subsequent to the pretreatment.

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

1. A pretreatment method for activating an electrode active material having a certain range of potential plateau beyond a redox potential range of a transition metal forming the electrode active material, which comprises charging the electrode active material to an extent exceeding the potential plateau at least once, so as to increase capacity of the electrode active material.

2. The pretreatment method according to claim 1, wherein the electrode active material is pretreated before it is charged for forwarding.

3. The pretreatment method according to claim 1, wherein the electrode active material has a potential plateau in a range of 4.4˜4.6V.

4. The pretreatment method according to claim 1, wherein the electrode active material comprises a compound in a solid solution state, represented by the following Formula 1:
XLi(Li_{1/3}M_{2/3})O₂+YLiM′O₂ (solid solution) [Formula 1]
Wherein M is at least one element selected from the group consisting of metals having an oxidation number of 4+;
M′ is at least one element selected from transition metals; and
0<X<1 and 0<Y<1, with the proviso that X+Y=1.

5. The pretreatment method according to claim 4, wherein M is at least one element selected from the group consisting of Mn, Sn and Ti metals, and M′ is at least one element selected from the group consisting of Ni, Mn, Co and Cr metals.

6. The pretreatment method according to claim 4, wherein the electrode active material shows a discharge capacity of 100˜280 mAh/g in a voltage range of 3.0˜4.4V, after the pretreatment.

7. An electrochemical device comprising an electrode active material that has a certain range of potential plateau beyond a redox potential range of a transition metal forming the electrode active material and is charged to an extent exceeding the potential plateau at least once, the electrochemical device being designed to be subjected to charge/discharge cycles at a voltage lower than the potential plateau.

8. The electrochemical device according to claim 7, wherein the electrode active material has a potential plateau in a range of 4.4˜4.6V.

9. The electrochemical device according to claim 7, wherein the electrode active material comprises a compound in a solid solution state, represented by the following Formula 1:
XLi(Li_{1/3}M_{2/3})O₂+YLiM′O₂ (solid solution) [Formula 1]
Wherein M is at least one element selected from the group consisting of metals having an oxidation number of 4+;
M′ is at least one element selected from transition metals; and
0<X<1 and 0<Y<1, with the proviso that X+Y=1.

10. The electrochemical device according to claim 9, wherein M is at least one element selected from the group consisting of Mn, Sn and Ti metals, and M′ is at least one element selected from the group consisting of Ni, Mn, Co and Cr metals.

11. The electrochemical device according to claim 9, wherein the electrode active material is activated in such a manner that it shows a discharge capacity of 100˜280 mAh/g in a voltage range of 3.0˜4.4V.

12. An electrochemical device comprising an electrode active material that has a certain range of potential plateau beyond a redox potential range of a transition metal forming the electrode active material, the electrochemical device comprising a means that allows the electrochemical device to be charged to an extent exceeding the potential plateau at least once, and then subjected to charge/discharge cycles at a voltage lower than the potential plateau.

13. The electrochemical device according to claim 12, wherein the electrode active material has a potential plateau in a range of 4.4˜4.6V.

14. The electrochemical device according to claim 12, wherein the electrode active material comprises a compound in a solid solution state, represented by the following Formula 1:
XLi(Li_{1/3}M_{2/3})O₂+YLiM′O₂ (solid solution) [Formula 1]
Wherein M is at least one element selected from the group consisting of metals having an oxidation number of 4+;
M′ is at least one element selected from transition metals; and
0<X<1 and 0<Y<1, with the proviso that X+Y=1.

15. The electrochemical device according to claim 14, wherein M is at least one element selected from the group consisting of Mn, Sn and Ti metals, and M′ is at least one element selected from the group consisting of Ni, Mn, Co and Cr metals.

16. The electrochemical device according to claim 14, wherein the electrode active material is activated in such a manner that it shows a discharge capacity of 100˜280 mAh/g in a voltage range of 3.0˜4.4V.

17. An electrode active material, which has a certain range of potential plateau beyond a redox potential range of a transition metal forming the electrode active material and is charged to an extent exceeding the potential plateau at least once.

18. An electrode active material, which has a certain range of potential plateau beyond a redox potential range of a transition metal forming the electrode active material and is charged to an extent exceeding the potential plateau at least once, and which is obtained by the pretreatment method as defined in claim 1.

19. The electrode active material according to claim 17, which is charged to an extent exceeding the potential plateau, and thus has O₂ deficiency formed by liberation of oxygen from the electrode active material at the potential plateau.

20. A compound represented by the following Formula 1 or a derivative thereof, which has a discharge capacity of 100˜280 mAh/g in a voltage range of 3.0 4.4V, and is present as a solid solution state:
XLi(Li_{1/3}M_{2/3})O₂+YLiM′O₂ (solid solution) [Formula 1]
Wherein M is at least one element selected from the group consisting of metals having an oxidation number of 4+;
M′ is at least one element selected from transition metals; and
0<X<1 and 0<Y<1, with the proviso that X+Y=1.

21. An electrode active material, which has a certain range of potential plateau beyond a redox potential range of a transition metal forming the electrode active material and is charged to an extent exceeding the potential plateau at least once, and which is obtained by the pretreatment method as defined in claim 2.

22. An electrode active material, which has a certain range of potential plateau beyond a redox potential range of a transition metal forming the electrode active material and is charged to an extent exceeding the potential plateau at least once, and which is obtained by the pretreatment method as defined in claim 3.

23. An electrode active material, which has a certain range of potential plateau beyond a redox potential range of a transition metal forming the electrode active material and is charged to an extent exceeding the potential plateau at least once, and which is obtained by the pretreatment method as defined in claim 4.

24. An electrode active material, which has a certain range of potential plateau beyond a redox potential range of a transition metal forming the electrode active material and is charged to an extent exceeding the potential plateau at least once, and which is obtained by the pretreatment method as defined in claim 5.

25. An electrode active material, which has a certain range of potential plateau beyond a redox potential range of a transition metal forming the electrode active material and is charged to an extent exceeding the potential plateau at least once, and which is obtained by the pretreatment method as defined in claim 6.
